(19) United States
(12) Patent Application Publication
(10) Pub. No.: US 2026/0268019 A1
(43) Pub. Date: Sep. 10, 2026

(54) SYSTEM AND METHOD FOR DIGITAL IDENTITY LIFECYCLE MANAGEMENT: UPFRONT RIGHTS SECURITIZATION, POSTHUMOUS AUCTIONING, AND BIDIRECTIONAL GENERATIVE SYNTHESIS

(71) Applicant: Akhil Vashisht, Elkhorn, NE (US)

(72) Inventor: Akhil Vashisht, Elkhorn, NE (US)

(21) Appl. No.: 19/651,806

(22) Filed: Apr. 20, 2026

(51) Int. Cl. G06F 21/62; G06F 21/16; H04L 9/08; H04L 9/32

(52) U.S. Cl. CPC G06F 21/6245; G06F 21/16; H04L 9/085; H04L 9/3231; H04L 9/3247; H04L 2209/608

(57) ABSTRACT

A platform for the secure lifecycle management of digital identities. The system enables living artists to securitize likeness rights and provides for an automated, estate-sanctioned revival via decentralized auctions and hardware-gated AI inference within Trusted Execution Environments (TEEs). Utilizing Spatio-Temporal Transformer (STTN) motion models and 4D Quaternion mathematics, the system achieves sub-50 ms bidirectional synchronization between a holographic avatar and live environmental transients. The system further includes a bidirectional synchronization module utilizing sensor data fusion and quaternion-based orientation to dynamically adapt the digital persona in real-time. Technical enforcement is maintained via Session Key handshakes and multi-domain ephemeral watermarking, ensuring compliance with the Tennessee ELVIS Act and the federal NO FAKES Act. The framework transforms legal property rights into a technical injunction, inhibiting unauthorized high-fidelity clones and long-form content generation at the hardware layer.

### CROSS-REFERENCE TO RELATED APPLICATIONS

This application is related to and incorporates by reference the entirety of co-pending U.S. patent application Ser. No. 19/639,311, titled “Self-Healing Generative AI Governance: The Triple-Bind Protocol for Persistent Multimodal Digital Provenance at the Inference-Layer,” filed Apr. 6, 2026. The present invention utilizes the Triple-Bind Protocol as the mandatory governance and self-healing substrate for the management of generative digital personas.

### STATEMENT REGARDING PRIOR DISCLOSURES BY THE INVENTOR

This application describes research and technical embodiments also described in the manuscript: Vashisht, Akhil (2025), “DO YOU WANT TO REVIVE YOUR FAVORITE DECEASED SINGERS USING ARTIFICIAL INTELLIGENCE TECHNOLOGY OR NOT?”, published in the Proceedings of the 65th International Association for Computer Information Systems Conference—Oct. 1-4, 2025|Clearwater, pp. 36-37. The inventor maintains priority of the embodiments described herein as of the date of this filing. Additionally, this application contains technical subject matter, identity management frameworks, and generative governance architectures also disclosed in the inventor's pending manuscript titled “A Human-Centric Architecture for Secure Digital Identity Lifecycle Management and Generative AI Governance,” submitted to the 2026 IEEE International Conference on Systems, Man, and Cybernetics (SMC 2026), currently under review.

### FIELD OF THE INVENTION

The present invention relates to the intersection of generative artificial intelligence (AI), hardware-level cybersecurity, digital rights management (DRM), and holographic display systems. More specifically, the invention provides a technical framework for managing an individual's digital identity across their entire lifecycle—from living securitization to posthumous generative revival—utilizing hardware-level cryptographic gating within Trusted Execution Environments (TEEs), bidirectional environmental synchronization via Spatio-Temporal Transformers, and a decentralized auction mechanism for authorized identity licensing and royalty distribution.

### BACKGROUND OF THE INVENTION

Post-Human Industry Context: By the second quarter of 2026, the global entertainment industry has transitioned into a “Post-Human” era, characterized by the emergence of large-scale posthumous holographic tours. A primary example is the ‘Signed to God World Tour 2026’ (Sidhu Moose Wala Estate, 2026), which utilizes advanced holographic projections to revive the late Punjabi icon Sidhu Moose Wala for audiences across Canada, the United States, and India. However, such current implementations are technically limited to “Static Playback Architectures” that rely on pre-rendered CGI or archival footage displayed via traditional optics such as the Pepper's Ghost illusion.

Environmental Interactivity Deficiencies: These existing systems are fundamentally “environmentally deaf.” They lack the architectural capability to adjust vocal delivery, physical mannerisms, or performance intensity in response to live instrumental improvisation, audience energy transients, or real-time improvisational prompts. As noted in the technical analysis of contemporary avatar choreography and virtual reality performances (Gochfeld et al., 2019), these systems operate as high-fidelity broadcasts rather than interactive performances.

Legal Landscape Evolution: The legal landscape has evolved in tandem with these technological shifts. The Tennessee Ensuring Likeness Voice and Image Security (ELVIS) Act (2024) and the federal Nurture Originals, Foster Art, and Keep Entertainment Safe (NO FAKES) Act (2025/2026) have established voice and likeness as primary property rights (Coons et al., 2025). Specifically, the ELVIS Act creates criminal and civil liability for the unauthorized simulation of an individual's voice (Tenn. Code Ann. § 47-25-1101 et seq.).

Technical Enforcement Gap: Despite these advancements, a “Technical Enforcement Gap” persists. While the law prohibits unauthorized replicas, it does not provide the technical tools to inhibit them at the point of creation. Current metadata-based frameworks remain vulnerable to “metadata stripping” and the “analog hole,” where re-photography or social media transcoding removes the digital chain of trust (Wagner & Blewer, 2019).

Necessity for Technical Injunction: Furthermore, the industry lacks a “Technical Injunction” mechanism—a way to inhibit high-fidelity AI inference at the hardware layer for anyone lacking explicit, estate-sanctioned authorization. There is no unified system that allows an artist to designate an Exclusive Successor Entity for their digital soul, ensuring that only one authorized company can produce high-fidelity content while automating the royalty stream for surviving beneficiaries and heirs.

Insufficiency of Detection-Based Prior Art: Existing conceptual frameworks (e.g., Vashisht, 2025, pp. 36-37) establish a baseline for managing digital credentials but fail to address the unique requirements of generative bidirectional synchronization or the hardware-level protection of model weights. Contemporary detection-only approaches often result in a “Technical Enforcement Gap,” as these tools typically achieve limited accuracy and are vulnerable to advanced generative capabilities (Ke Wang et al., 2025). Prior art, such as U.S. Pat. No. 8,538,848 (Myhrvold et al.) and Martin-Rodriguez et al. (2023), demonstrates that pixel-wise feature extraction is insufficient for persistent provenance. Without a unified technical injunction—such as the Triple-Bind Protocol substrate disclosed in co-pending U.S. patent application Ser. No. 19/639,311—estates are forced into reactive battles against unauthorized clones.

Technical and Regulatory Necessity: There is, therefore, a dire technical and regulatory necessity for a system that bridges the gap between an artist's “Digital Will” and the secure, technical enforcement of their digital likeness, transforming the “Illegal Deepfake” problem into a technical impossibility for anyone lacking a valid, estate-issued Session Key.

### SUMMARY OF THE INVENTION

Vault-to-Stage Pipeline: The present invention provides a comprehensive “Vault-to-Stage” pipeline for the secure management of digital personas. For living artists, it enables the secure ingestion and “Vaulting” of Master Biometric Primitives, including Retrieval-based Voice Conversion (RVC) weights (Chun et al., U.S. Pat. No. 10,249,289) and skeletal motion meshes, as well as the upfront securitization of future earnings.

Posthumous Identity Rights Enforcement: For posthumous artists, the invention provides an autonomous auction and licensing platform that enforces the artist's identity rights through a Session Key Handshake executed within a hardware-isolated Trusted Execution Environment (TEE). The hardware-isolated TEE utilizes TensorRT acceleration for real-time inference-layer gating (Stefanakis & Han, 2026).

Generative Synchronization Engine: The system introduces a Spatio-Temporal Transformer (STTN) (Nargund & Sra, 2023) that utilizes a decoupled attention mechanism to map live environment transients into 3D skeletal joint orientations with sub-50 ms latency. To ensure fluidity and eliminate Gimbal Lock, the system calculates rotations using 4D Quaternion mathematics, as opposed to standard neural animation baselines (Bosworth, U.S. Pat. No. 12,513,102).

Cryptographic Provenance and Watermarking: Technical enforcement is driven by a Session Key Handshake that integrates with the Triple-Bind Protocol described in U.S. patent application Ser. No. 19/639,311. Every frame of synthetic output is embedded with a distributed steganographic watermark containing a recovery UUID. The system utilizes a deep-learning-based detector to solve for the original identity message even if the asset has undergone a 50% reduction in data integrity.

Automated Royalty Management: The system incorporates an automated Tripartite Royalty Distribution engine. Every payment generated by the identity auction is split via a smart contract among verified beneficiaries, the technical proxy company, and legacy equity investors, maintaining compliance with digital performance royalty standards (RIAA, 2026).

Public Commons Mode: In cases where no legal heirs exist, the system is configured to enter a “Public Commons Mode,” where proceeds are automatically diverted to a designated charitable trust, ensuring the artist's legacy remains a social positive.

Exclusive Successor Proxy Moat: By establishing the Company as the Exclusive Successor Proxy during the living phase, the system ensures that the technical inception keys required to revive the high-fidelity persona are hard-coded to only communicate with the Company's authorized servers, providing an unbreakable technical moat against competitors.

Transformation of Legal Rights to Technical Reality: Ultimately, the invention transforms a legal property right established by the ELVIS Act into a technical reality, ensuring that the human original remains the master of their own digital legacy forever.

### BRIEF DESCRIPTION OF THE DRAWINGS

FIG. 1 is a high-level architectural block diagram of the Digital Identity Lifecycle Management System 100, illustrating the functional relationship between the live venue 102, the hardware-gated TEE inference layer 120, and the identity management suite 130.

FIG. 2 is a process flowchart detailing the lifecycle transition process 200 from a living artist state 202 to the posthumous decentralized auction 242 via an autonomous Dead Man's Switch 222.

FIG. 3 is a functional block diagram of the bidirectional generative sync system 300, detailing the internal logic of the STTN transformer 320, the Quaternion rotation engine 330, and a selectable parametric aging module 360.

FIG. 4 is a logic flowchart of the governance oracle logic flow 400, illustrating the operational steps of the Reed-Solomon recovery loop 480 for the self-healing of digital provenance.

FIG. 5 is a Graphical User Interface (GUI) wireframe of the Master Identity Exchange GUI 500, illustrating the interface through which licensees bid for time-limited Session Keys 250.

### DETAILED DESCRIPTION OF THE INVENTION

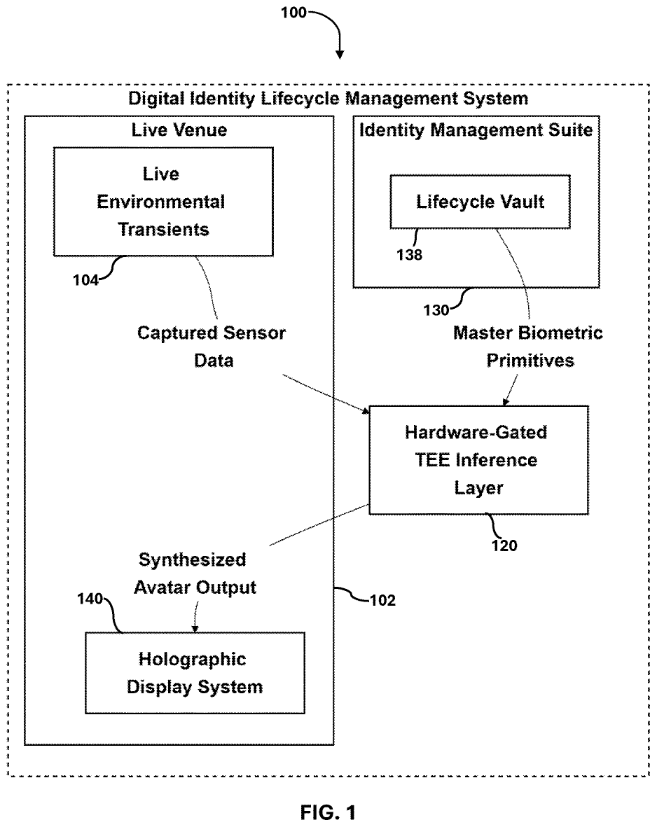

Identity as a Service Operationalization: The present invention operationalizes “Identity as a Service” (IDaaS) by tethering legal property rights to hardware-level access controls. Referring to FIG. 1, the overall Digital Identity Lifecycle Management System 100 bridges a live venue 102 with a secure identity management suite 130 via a hardware-gated TEE inference layer 120. A holographic display system 140 at the live venue 102 outputs the synthesized avatar in response to live environmental transients 104 captured on stage.

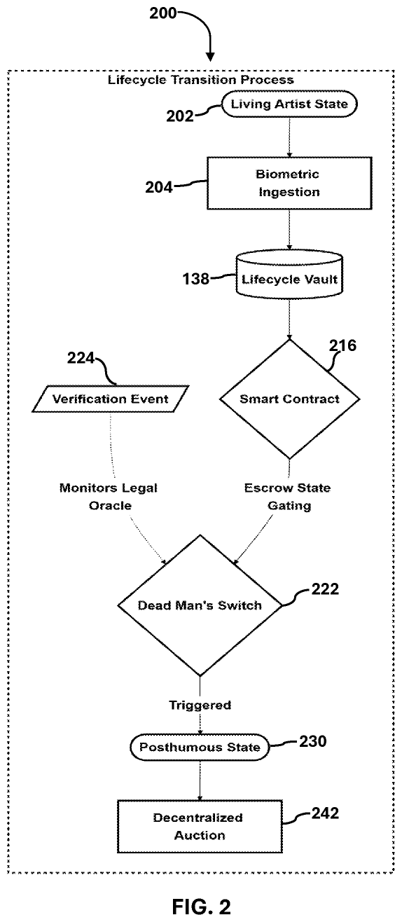

Biometric Ingestion and the Master Identity Vault: The process begins with the ingestion of “Master Biometric Primitives.” Referring to FIG. 2, biometric ingestion 204 occurs while the artist is in a living artist state 202. The system performs high-resolution vocal capture to train an RVC model and 52-point skeletal motion captures. These primitives are encrypted and securely stored in a Lifecycle Vault 138 housed within the identity management suite 130.

Master Identity Vault Storage Architecture: The Lifecycle Vault 138 is implemented as a multi-tier storage architecture: (a) Cold Vault—long-term, offline encrypted blobs stored with multi-party custody; (b) Warm Staging—time-limited encrypted artifacts; and (c) Hot Staging—ephemeral blobs provisioned into the hardware-gated TEE inference layer 120 for active inference. The vault enforces threshold cryptography for master key custody.

Successor Proxy Designation: During the living phase, the artist executes a “Digital Successor Clause” within a smart contract 216. This designates the Company as the exclusive technical proxy for the artist's persona upon death, creating a technical link wherein inception keys only communicate with authorized servers.

Dead Man's Switch Operational Logic: Referring again to FIG. 2, the lifecycle transition process 200 from the living artist state 202 to a posthumous state 230 is governed by an autonomous Dead Man's Switch 222. Upon detecting a Verification Event 224 (such as an estate probate filing) from a Legal Oracle, the artist's Identity Soulbound Token (ISBT) flips to an “Auctionable” status.

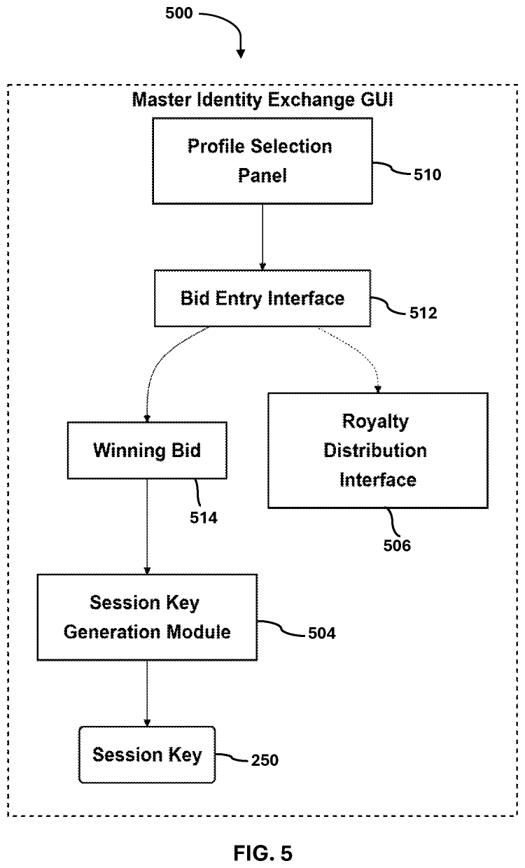

Decentralized Auction of Soulbound Tokens: Licensing is handled through a decentralized auction 242. As illustrated in FIG. 5, producers interact via the Master Identity Exchange GUI 500, utilizing a profile selection panel 510 and a bid entry interface 512 to bid on time-limited Session Keys 250. The winning bid 514 triggers a Session Key generation module 504, granting a Session Key 250 in the form of a cryptographic token that enables a temporary inference session. Royalty splits are calculated and tracked via a royalty distribution interface 506.

Trusted Execution Environment (TEE) Hardware Gating: To prevent piracy, AI inference occurs exclusively within the hardware-gated TEE inference layer 120. The system utilizes TensorRT acceleration for real-time neural rendering (Stefanakis & Han, 2026). The Session Key 250 is required to initialize the inference gate. Without this key, weights remain encrypted.

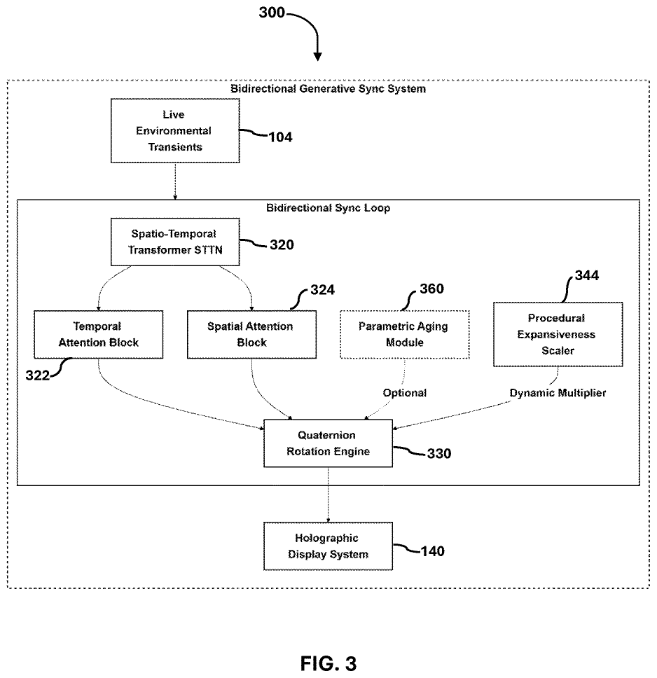

Bidirectional Generative Syne Engine: Referring to FIG. 3, the bidirectional generative sync system 300 achieves live interactivity through a Bidirectional Sync Loop 302. The STTN 320 analyzes live environmental transients 104 from the live venue 102 to predict the next pose of the hologram.

Decoupled Attention Mechanisms in STTN: The STTN 320 utilizes a dual-attention block architecture: (i) a Temporal Attention block 322, which analyzes the history of a specific joint to maintain momentum; and (ii) a Spatial Attention block 324, which analyzes the skeleton's structure to ensure biomechanical plausibility.

Spatio-Temporal Transformer Interpolation: The STTN 320 input pipeline includes spectrogram windowing and attention head configurations. Outputs are normalized 4-D quaternions; interpolation uses Spherical Linear Interpolation (SLERP) to ensure smooth transitions between predicted poses q₁ and q₂ The interpolation is governed by the formula:

$$Slerp ( {q}_{1} , {q}_{2} , t ) = ( sin ( ( 1 - t ) \cdot θ ) / sin θ ) \cdot {q}_{1} + ( sin ( t \cdot θ ) / sin θ ) \cdot {q}_{2}$$

where q₁ represents the initial quaternion pose, q₂ represents the target quaternion pose, θ is the angle between the quaternions, and t is the interpolation factor (0≤t≤1)

Quaternion Skeletal Mathematics: Within the Quaternion rotation engine 330, joint rotations are calculated as 4D Quaternions to avoid mathematical singularities. The formula for rotation interpolation is:

$$Q = [ w , x , y , z ] = [ cos ( α / 2 ) , {n}_{x} \cdot sin ( α / 2 ) , {n}_{γ} \cdot sin ( α / 2 ) , n\_z \cdot sin ( α / 2 ) ]$$

where w, x, y, z represent the four components of the quaternion Q, α is the rotation angle in radians, and nₓ, n_{y}, and n_z are the unit components of the rotation axis.

Procedural Expansiveness Scaler: The system utilizes a procedural expansiveness scaler 344 to analyze environmental audio energy. If cheering exceeds a threshold, the scaler 344 applies a dynamic multiplier to the joint rotations within the Quaternion rotation engine 330, causing the avatar to perform with increased energy.

Digital Voice Protection Gating: The present invention gates RVC weights behind the Session Key 250. As identified by Genelza (2024), unauthorized voice cloning represents a significant threat to artist identity that requires hardware-isolated inference protection.

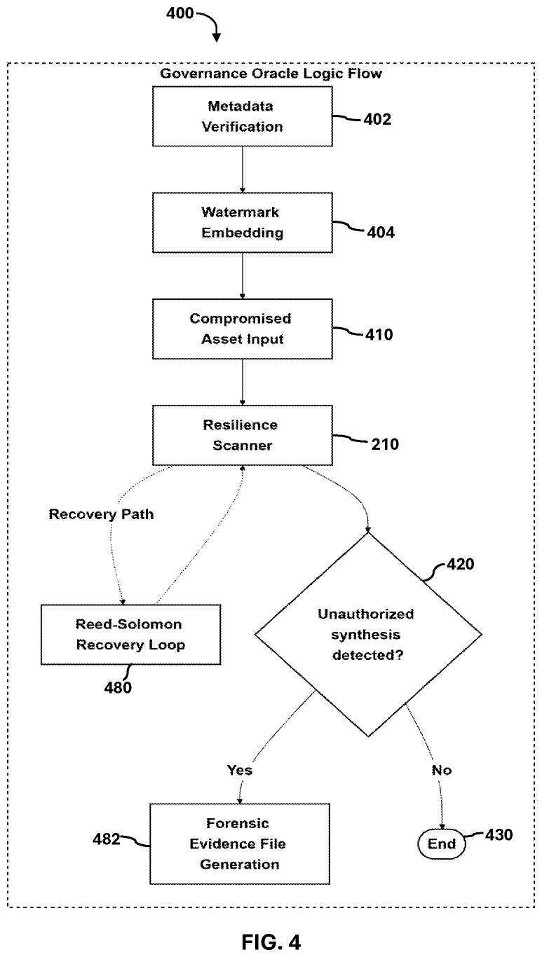

Mathematical Logic of the Resilience Scanner: Referring to FIG. 4, the Governance Oracle 124 operates a governance oracle logic flow 400 that initiates a metadata verification step 402, followed by a watermark embedding step 404. An asset suspected of being unauthorized is provided to the system as a compromised asset input 410. The system utilizes a resilience scanner 210 and a Reed-Solomon recovery loop (Reed & Solomon, 1960) 480 to extract the recovery UUID even if the asset has undergone a 50% reduction in data integrity. The embedding function is:

$${I}_{w} = I + α \cdot Φ ( W )$$

where I_{w} is the resulting watermarked asset, I is the original asset, α is a scaling factor for imperceptibility, Φ represents the spatial-frequency transformation, and W is the watermark.

Forensic Evidence File Generation: The resilience scanner 210 solves for the original identity message (M) by minimizing a loss function (L) between a detector (D) and a compromised signal (I′_{w}):

$$L ( D ( {I}_{w}^{′} ) , M )$$

where Z is the calculated loss, D is the trained detector, I′w represents the compromised signal, and Mis the original identity message. In the event that an unauthorized synthesis is detected, decision 420 is “Yes,” this recovery triggers the automated Forensic Evidence File generation 482. If the decision 420 is “No,” indicating the asset is authorized or benign, the logic flow reaches an end state 430.

Distributed Ledger for Provenance Registration: Every authorized inference session is logged to a distributed ledger within the identity management suite 130. This creates an immutable record of “Truth” that can be cross-referenced by third-party platforms to verify that a digital performance was legally licensed via the auction platform 242.

High-Fidelity Multi-Genre Training: The system is configured to ingest archival recordings spanning an artist's entire career. By training the generative models on multi-genre datasets (e.g., training on Elvis Presley's rock, gospel, and pop recordings), the system enables the generation of new content in diverse musical styles while maintaining the unique biometric “fingerprint” of the original artist.

Improvisational Stage Movement: Unlike static CGI, the sync engine 300 enables the avatar to react to live instrumentalists. If a live band extends a musical bridge, the STTN 320 detects the rhythmic shift and generates novel, biomechanically consistent stage presence movements that were never recorded during the artist's lifetime.

Hardware-Isolated Inference Decoupling: To maximize security, the generative model is partitioned into a sensitive partition (biometric weights) and a non-sensitive partition (general motion physics). Only the sensitive partition is provisioned to the TEE inference layer 120, ensuring that even if the non-sensitive partition is breached, the artist's unique identity remains protected.

Multimodal Scaling and Parametric Aging: The biometric primitives ingested by the ingestion module 204 consist of RVC weights and deep learning motion meshes. The system optionally includes a parametric aging module 360, as visually conceptualized in FIG. 3, configured to extrapolate biometric primitives and vocal formants to a desired chronological point. This enables the selectable generative synthesis of the digital persona at an archival baseline age (age at time of death), a regressed age (younger), or a chronologically advanced age (older), allowing the Master Identity Vault 138 to serve as a universal, adaptive standard for identity preservation.

Real-Time Environment Mapping: The holographic display system 140 utilizes environmental sensors to map the venue's lighting. This data is fed back into the inference layer 120 to ensure the synthetic skin shaders of the hologram match the local lighting conditions in real-time, achieving sub-50 ms visual integration.

Performance SLA and Latency Budget: To maintain the illusion of life, the total round-trip latency (Lₜₒₜₐₗ) within the Bidirectional Sync Loop 302 is governed by the technical summation:

$${L}_{total} = {L}_{acq} + {L}_{inf} + {L}_{rend} < 50 ms$$

where Lₜₒₜₐₗ is the total system latency, L_{acq} represents sensor acquisition and spectral windowing latency, L_{inf} represents the forward model forward pass (inclusive of TEE enclave overhead), and L_{rend} represents the final holographic rendering and display pipeline latency.

Dynamic Crowd Response Scaling: The procedural expansiveness scaler 344 monitors audience volume transients 104. When crowd engagement increases, the scaler 344 adjusts the “amplitude” of the generative model's performance, resulting in larger gestures and more powerful vocal delivery to simulate real-world performer-audience feedback loops.

Secure Session Termination: If the Governance Oracle 124 detects a violation of pre-signed usage constraints (e.g., the avatar being used to endorse a prohibited brand), the inference gate in the TEE layer 120 terminates the Session Key 250 instantly, cutting the synthetic feed.

Decentralized Beneficiary Management: The royalty distribution interface 506 allows heirs to manage their wallet addresses and view real-time earnings from the decentralized auction 242. This removes the administrative overhead of traditional estate management companies.

Cross-Platform Deployment: Once licensed via a Session Key 250, the persona can be deployed across various authorized environments, including VR headsets, augmented reality glasses, and venue-scale holographic projectors, all while maintaining the hardware-level “Technical Injunction.”

Legacy Charitable Trusts: For artists without heirs, the smart contract 216 is programmed to automatically route 100% of the auction proceeds to a designated charitable 501(c)(3) entity, ensuring the artist's digital revival funds social good.

The “Analog Hole” Mitigation: By embedding watermarks at the inference layer 120, the system ensures that even if a performance is recorded by a smartphone in the audience, the resulting video file still contains the verifiable UUID traceable back to the original authorized session.

Exclusive Successor Technical Moat: The hard-coding of technical inception keys to specific authorized servers 130 ensures that no competitor can utilize the vaulted primitives, even if the legal estate is later sold, effectively creating a perpetual “Technical Moat” for the original Successor Proxy.

Transformation of Property to Hardware Logic: The invention successfully transitions the “Right of Publicity” from a legal concept that is hard to litigate into a hardware-logic gate that is impossible to bypass without authorization.

Conclusion of the Preferred Embodiment: Ultimately, the system 100 provides a secure, ethical, and interactive framework for the digital afterlife of performing artists, protecting their biometric integrity while enabling continued creative and financial legacy.

The present invention provides a Bidirectional Synchronization Module configured to establish a real-time feedback loop between a digital persona and a physical environment. Unlike conventional systems that utilize pre-rendered assets for static playback, the Bidirectional Synchronization Module facilitates dynamic interaction by processing multi-modal environmental inputs to adjust the digital persona's output parameters in real-time.

In one embodiment, the synchronization logic utilizes a Sensor Data Fusion layer. This layer aggregates high-fidelity telemetry from a suite of environmental sensors, including, but not limited to, Time-of-Flight (ToF) sensors for depth mapping and Infrared (IR) sensors for thermal tracking of physical participants. This fused data set is processed to generate a spatial-awareness map of the immediate physical vicinity.

The spatial-awareness map is then ingested by the Quaternion Rotation Engine 330. By utilizing quaternions for orientation calculations, the system avoids gimbal lock and ensures fluid, low-latency movement of the digital persona's Neural Mesh. Specifically, the Quaternion Rotation Engine 330 calculates the optimal orientation of the persona's gaze and skeletal structure to align with the real-time coordinates of a physical participant identified by the Sensor Data Fusion layer.

Simultaneously, the module maintains synchronization with the RVC Biometric Ingestion 204 and the Royalty Interface 506. As environmental triggers (e.g., verbal cues or physical proximity) alter the persona's behavioral state, the system dynamically queries the RVC weights to adjust vocal timbre and inflection. Every such interactive cycle is logged via the Royalty Interface 506, ensuring that the usage of specific biometric primitives is tracked for automated tiered revenue distribution.

This bidirectional approach represents a significant technical departure from existing “persona simulation” baselines-such as those disclosed in U.S. Pat. No. 12,513,102 (Bosworth)—which focus primarily on language model responses without integrated, low-latency physical environmental synchronization. By coupling sensor fusion with the Quaternion Rotation Engine 330, the present invention achieves a level of physical-digital parity that exceeds traditional pre-rendered holographic displays.

1. A system for the digital identity lifecycle management of a performing artist, comprising:
a high-security lifecycle vault containing a plurality of encrypted master biometric primitives;
a decentralized auction platform configured to license the plurality of encrypted master biometric primitives via an Identity Soulbound Token (ISBT);
a hardware-isolated Trusted Execution Environment (TEE) configured for generative AI inference;
an inference gate configured to inhibit a synthetic output absent a verified Session Key Handshake; and
a bidirectional sync engine comprising a Spatio-Temporal Transformer (STTN) configured to map a plurality of live environmental transients into a plurality of 3D skeletal joint rotations in real-time.

2. The system of claim 1, wherein the 3D skeletal joint rotations are calculated using four-dimensional Quaternion mathematics to enable gimbal-lock-free movement of a holographic avatar.

3. The system of claim 1, further comprising a Succession Oracle and a smart contract configured to automatically distribute licensing royalties from the decentralized auction platform to verified beneficiaries or a designated charitable trust according to a tripartite predetermined ratio.

4. The system of claim 1, further comprising an Exclusive Successor Proxy status established within the lifecycle vault, wherein the technical inception keys required for decryption are hard-coded to an exclusive authorized server to preclude unauthorized third-party synthesis.

5. The system of claim 1, further comprising a Governance Oracle situated at an inference layer, the Governance Oracle configured to embed a distributed steganographic watermark containing a recovery UUID into every frame of the synthetic output.

6. A method for the technical enforcement of digital identity rights, comprising:
encrypting a biometric identity into a lifecycle vault in an escrow state; monitoring a legal oracle via a dead-man's switch to transition from the escrow state to an auction state;
issuing a unique, time-limited Session Key to an authorized licensee; and
utilizing the Session Key as a mandatory cryptographic requirement to decrypt a plurality of master biometric primitives at a hardware-isolated inference layer.

7. The method of claim 6, further comprising extracting a steganographic watermark utilizing a deep-learning-based recovery loop configured to solve for an original identity message (M) by minimizing a loss function (L) between a detector (D) and a compromised signal (I′_{w}) to generate a Forensic Evidence File in the absence of a valid Session Key.

8. The method of claim 7, wherein the Forensic Evidence File is utilized to seek injunctive relief and statutory fines under the ELVIS Act and the NO FAKES Act for the unauthorized creation of cinematographic, musical, or auditory works.

9. The system of claim 1, wherein the generative model is partitioned into a sensitive partition and a non-sensitive partition during training, and wherein only the sensitive partition is provisioned to the hardware-isolated Trusted Execution Environment for inference.

10. The system of claim 1, further comprising a threshold cryptography module that splits the master decryption key into (n) shares distributed among at least three independent custodians, wherein a threshold (t) of shares is required to reconstruct the key for vault state transitions.

11. The system of claim 5, wherein the distributed steganographic watermark is session-scoped and cryptographically bound to the Session Key such that watermark validity expires upon Session Key revocation.

12. The method of claim 6, wherein issuance of the unique, time-limited Session Key requires remote attestation of the licensee's hardware and verification of a Governance Compliance Proof prior to key handoff.

13. The method of claim 7, wherein the generated Forensic Evidence File is digitally signed by the detecting system and its hash is anchored to a public ledger to provide immutable proof of unauthorized generation.

14. The system of claim 1, wherein training data and model updates are performed under a partition-before-training regimen that prevents identity-specific parameters from being exported in non-sensitive model checkpoints.

15. The system of claim 5, wherein the distributed steganographic watermark is embedded across at least two domains selected from the group consisting of spatial-frequency image domain, audio spectral domain, and temporal micro-modulation domain.

16. The system of claim 1, further comprising a policy filter that enforces pre-signed usage constraints at inference time and terminates sessions that attempt to violate the constraints.
